(19) United States
(12) Patent Application Publication
(10) Pub. No.: US 2008/0076103 A1
(43) Pub. Date: Mar. 27, 2008

(54) Electronic book

(76) Inventor: Thomas B. Wallace, Covington, LA (US)

Correspondence Address: Raymond M. Galasso;Galasso & Associates LP, P.O. Box 26503, Austin, TX, 78755-0503, US

(21) Appl. No.: 11/900,598

(22) Filed: Sep. 12, 2007

Related U.S. Application Data
(60) Provisional application No. 60/844,958, filed on Sep. 15, 2006.

(51) Int. Cl. G09B 5/06; G09G 5/00

(52) U.S. Cl. 434/317; 345/156; 434/156; 707/104.1

(57) ABSTRACT

A portable electronic book designed to receive data from a removably insertable media and provide that data to a user in a graphical or audio format. The portable electronic book includes a housing that has mounted therein display screens and audio output devices that function to provide data to a user. The portable electronic book further includes conventional computer electronics that function to receive data from a data source in a first language and subsequently translate that data into a second language and provide the data to a user either independently or in conjunction in a text or audio format. The portable electronic book also includes an output device for interfacing with peripheral devices such as a printer. Releasable secured within the housing is a power source such as a lithium ion battery.

### PRIORITY UNDER 35 U.S.C. 119(e) & 37 C.F.R. 1.78

This nonprovisional application claims priority based upon the following prior United States provisional patent application entitled: Only book by human imagineering, Application No.: 60/844,958 filed Sep. 15, 2006, in the name of Thomas B. Wallace, which is hereby incorporated by reference for all purposes.

### FIELD OF THE INVENTION

The present invention relates to an information storage and display device, more specifically but not by way of limitation a portable electronic book that receives information via a removably insertable CD or DVD allowing the user to view the material stored on the CD or DVD via a display screen.

### BACKGROUND

In the past decades there has been a saturation of print media in the forms of magazines, periodicals, and books. The production amount of these types of media has resulted in problems for everyone from institutions to individuals when handling the task of storing all of the paper based materials. Most individuals and institutions have had to utilize additional offsite storage as a result of insufficient space required to accommodate the paper based materials.

Another issue involved with traditional books and magazines is cost. The cost of purchasing books and magazine has increased dramatically over the last decade. Utilization of paper based materials such as periodicals can also prove to be cumbersome and difficult if an individual needs to travel and transport the materials with them to a desired location. Furthermore, as the global economy expands, reducing the consumption of our natural resources required to produce the paper based materials should become a priority.

Additionally, paper based materials are most often available in one language in a particular region or country. As more businessmen and individuals travel and conduct business or engage in leisure in different countries, regionally printed paper based materials do not offer a method for deciphering the language for those who do not read or speak the language in which the information is printed.

Accordingly, there is a need for a paperless information retrieval and display system that allows a user to view, manipulate and store information that is commonly available via printed media such as books or magazines.

### SUMMARY OF THE INVENTION

It is the object of the present invention to provide an electronic book that will allow a user to view information via a display screen that has been inputted into the device via a removably insertable storage device such as but not limited to a computer disc.

Another object of the present invention is to provide a method of receiving and displaying information from two different sources simultaneously allowing the user to compare the information.

It is a further object of the present invention to provide an electronic book that will utilize heat sensor pads as a user interface to allow the user to manipulate the information displayed on the screen of the electronic book.

Yet a further object of the present invention is to provide an electronic book that will allow a user to read the material in low light situations.

Another object of the present invention is to provide an electronic book that will also provide the user with an audio version of the information contained on the storage device that has been removably inserted into the electronic book.

A further object of the present invention is to provide an electronic book that will provide language translations of the information input thereinto and output the information in an audio or graphical format to the user.

A further object of the present invention is to provide an electronic book that appears and behaves very much as the paper based codex appears and behaves in order to provide information and retrieval systems to those potential users who are computer averse or who find the output formats of computer screens difficult to use.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWING

A more complete understanding of the present invention may be had by reference to the following Detailed Description and appended claims when taken in conjunction with the accompanying Drawing wherein:

FIG. 1 is a perspective view of an embodiment of the present invention.

### DETAILED DESCRIPTION

Referring now to the drawing submitted herewith, wherein various elements depicted therein are not necessarily drawn to scale and wherein throughout the FIGURE like elements are identified with like reference numerals, there is illustrated a digital display device 100 constructed according to the principles of the present invention.

The digital display device 100 comprises a housing 10 that includes a first portion 20 and a second portion 25. The housing 10 is manufactured from a suitable durable material such as but not limited to plastic. The housing 10 is generally rectangular in shape and functions to provide protection for the electronic components that are disposed therein that are necessary to receive, store, manipulate and project data files. The housing 10 further includes a plurality of lateral side walls 30 that are designed to provide a decorative look of a traditional book when the first portion 20 and the second portion 25 are adjacent to each other.

A hinge 35 is intermediate the first portion 20 and the second portion 25 of the housing 10. The hinge 35 extends along the inner longitudinal edge 40 of the first portion 20 and the second portion 25 of the housing 10. The hinge 35 functions to hingedly secure the first portion 20 of the housing 10 to the second portion 25 so that a user may move the first portion 20 relative to the second portion 25 where the angle between the first portion 20 and the second portion 25 generally opens to a range between zero degrees to one hundred and eighty degrees. While no particular size of housing 10 is required, good results have been achieved manufacturing a housing that is approximately nine to fourteen inches in height, five to eight inches in width and one-half to two and one half inches in thickness.

Display screens 45 are mounted on the first portion 20 and the second portion 25 of the housing 10. The display screens 45 are conventional LCD screens functioning to display information in the forms of graphical text, still images, or moving images to the user. The display screens 45 are operably connected to electronic components disposed within the housing 10. It is further contemplated within the scope of the present invention that the display screens 45 could also be a mutual capacitance screen. As is known in the art, a mutual capacitance touch-screen contains a grid of sensing lines and driving lines to determine where a user is touching the screen. The display screens 45 could be manufactured in this manner so as to provide the user an interface to manipulate the data or images displayed on the screen or as a method of controlling the digital display device 100. Furthermore, it is contemplated within the scope of the present invention that the display screen 45 is coated with a protective anti-reflective coating to reduce glare and protect the glass substrate of the display screens 45. It is also contemplated within the scope of the present invention that the display screens 45 have lighting in order to allow a user to view the images displayed thereon in dim or low light conditions.

The digital display device 100 functions to allow the user to manipulate the text or images that are displayed on the display screens 45. More specifically but not by way of limitation, the digital display device 100 allows the user to enter commands utilizing the sensor pads 65 that are operably connected to conventional electronic components disposed within the housing 10 so as to allow the user to change the font size of the text displayed on the display screens 45. This allows a user who may be at least partially visually impaired to view the text displayed on the display screens 45. Furthermore, it is contemplated within the scope of the present invention that the user could magnify any image displayed on the display screens 45 in order to enhance vision of that image to a user that may be at least partially visually impaired.

The sensor pads 65 may also more specifically but not by way of limitation, allow the user to move through pages of text or photos or other digital displays that have been preformatted in “codex display” format, thus turning the pages of the electronic book physically through the sensor pads 65 rather than scrolling text in the traditional computer model.

A plurality of speakers 60 are integrally mounted on the first portion 20 and the second portion of the housing 10 generally adjacent the display screen 45 and proximate the upper edge 65. The speakers 60 are conventional audio speakers that are operably controlled by electronic components to produce sounds from a desired data file that has been inputted into the digital display device 100. Those skilled in the art will recognize that numerous different amounts of speakers 60 could be utilized in order to achieve the desired result as defined herein. It should also be recognized that the speakers 60 could be integrally mounted into the housing 10 in a plurality of different locations. It is further contemplated within the scope of the present invention that the digital display device 100 have the necessary electronic components to receive data files in any format such as but not limited to text data files and in conjunction with displaying the text of the data file on the display screen 45 produce the audio of the text through the speakers 60. Additionally, it is contemplated that the digital display device 100 have the necessary electronic components to translate the text of a data file from a first language into the text of second language and in conjunction therewith produce the audio of the first or second language via the speakers 60.

A plurality of sensor pads 65 are integrally mounted into the housing 10 adjacent the display screens 45. The sensor pads 65 are manufactured from a suitable material functioning to allow a user control the digital display device 100. Materials such as but not limited to a layer or multiple layers of capacitive material would be suitable for manufacturing the sensor pads 65. It is also contemplated within the scope of the present invention that the sensor pads 65 could be manufactured to respond to the heat of a user's finger that is engaged therewith. The sensor pads 65 function to allow the user to manipulate the information projected on the display screens 45. More specifically but not by way of limitation, the sensor pads 65 function to permit a user to scroll through text or graphical data produced from an inputted data file that exceeds the display area of the display screen 45 Additionally the sensor pads 65 would allow a user to manipulate the data displayed from more than one stored data file such that the images or text from one file could be displayed adjacent to the images or text from a second data file. Although the sensor pads 65 are shown in the drawing submitted herewith as being generally rectangular in shape, those skilled in the art will recognize that the sensor pads 65 could be manufactured in numerous different shapes. Furthermore, it is also contemplated within the scope of the present invention that the sensor pads 65 could be mounted on the housing 10 in numerous different locations.

A data input device 70 is integrally mounted with the side wall 12 of the second portion 25 of the housing 10. The data input device 70 is operably connected to the electronic components disposed within the housing 10 such that the digital display device 100 can receive, store, manipulate and provide to a user the data transmitted from the data input device 70. It is contemplated within the scope of the present invention that data input device 70 would contain data files such as electronic books or magazines. The data input device 70 is a conventional optical disc device such as a CD-ROM or DVD drive. It is further contemplated that the data input device 70 could also be a hard drive, memory card such as a USB thumb drive or SIMM card device thereby allowing a user to utilize the digital display device 100 to receive, store, manipulate and provide the data files contained on those devices. The digital display device 100 has the necessary electronic components such as but not limited to memory chips that would allow the user to either view the data directly from a media format that has been removably inserted via the data input device 70 or transfer the data and store the data into the digital display device 100 for subsequent viewing. It is further contemplated within the scope of the present invention that the digital display device 100 could be configured to receive data files through alternative methods. More specifically but not by way of limitation, the digital display device 100 could be configured to receive data files to store, view and manipulate from networks, including a wireless networks or the internet.

An audio output jack 80 is mounted adjacent the data input device 70 on the side wall 12 of the housing 10. The audio output jack 80 is operably connected to the electronic components disposed within the housing 10. The audio jack 80 is a conventional audio output interface that allows a user to operably couple listening devices such as but not limited to headphones in order to hear the sound produced by the digital display device 100 in place of and/or in conjunction with the speakers 65. Although the digital display device 100 is illustrated in the drawings submitted herewith as having one audio output jack 80, it is further contemplated within the scope of the present invention that the digital display device 100 could have mounted thereon more than one audio output jack 80.

A printer interface 85 is mounted on the side wall 14 of the first portion 20 of the housing 10. The printer interface 85 is operably connected to the necessary electronics disposed within the housing 10 to allow a user to print the text or images from digital display device, including those displayed on the display screen 45. It is contemplated within the scope of the present invention that the printer interface 85 could be manufactured as a network interface, firewire interface, wireless printer interface, serial interface, USB interface or a parallel port interface.

A power source 90 is operably connected to the digital display device 100. The power source 90 is integrally mounted on the side wall 14 of the first portion 20 of the housing 10 and is operably connected to electronic components disposed within the housing 10 so as to provide the necessary power to operate the digital display device 100. While no particular type of power source 90 is required, good results have been achieved by utilizing a rechargeable battery pack, such as a lithium ion battery. It is further contemplated within the scope of the present invention that the digital display device 100 could also be equipped with an interface to allow a user to utilize an external power supply, such as an AC or DC power supply to provide the necessary power to operate the digital display device 100.

It is further contemplated within the scope of the present invention that the digital display device 100 utilizes the control electronics disposed within the housing 10 to allow the digital display device 100 to interpret and reformat data files from numerous different available computer programs. By way of example only, and not by way of limitation, the digital display device 100 could read, interpret and reformat data files with file extensions of .txt, .doc, .pdf.

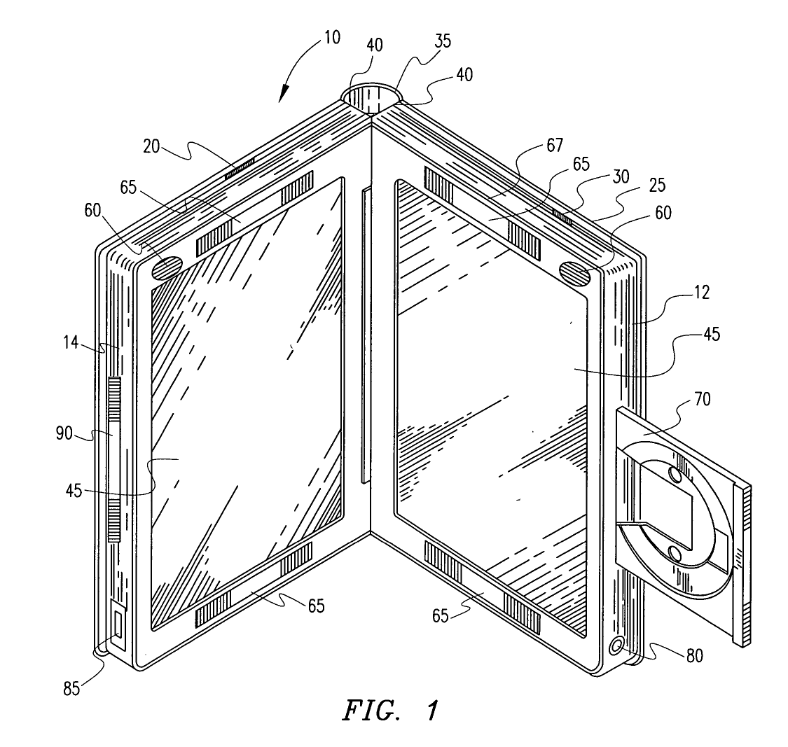

Referring in particular to FIG. 1, a description of the operation of the digital display device 100 is as follows. In use, a user will connect the digital display device 100 to the desired power source 90 in order to provide the necessary power to operate the digital display device 100. A user will then select the desired data files from an insertable media format such as but not limited to a CD-ROM and removably insert the CD-ROM containing the desired information into the data input device 70. Electronic components disposed within the housing 10 will receive, store and process the data that has been transferred from the data input device 70 into the digital display device 100. Subsequent to storage of the information in the digital display device 100, the user can then utilize the sensor pads 65 to access, manipulate and view the data. During processing and manipulation of the data the user can have the information translated from a first language into a second language and have the second language displayed on the display screen 45 in conjunction with the first or second language converted to an audio file and simultaneously played therewith through the speakers 60. Additionally, the user can manipulate the text or graphical images displayed on the display screen 45 in order to enhance their visibility by methods such as zooming or altering the font size.

Once a user has completed viewing the information on the display screens 45, the user will place the first portion 20 and the second portion 25 adjacent to each other simulating a closed position of a book.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An electronic book comprising:
controller, said controller for receiving, storing, manipulating and viewing data, said controller further being configured to provide the data to a user in at least two modes;
an user interface, said user interface being configured for allowing a user to input control functions, said user interface further being configured to control the viewing and manipulation of the data stored in the electronic book; and
at least two display screens, said display screens for displaying data stored within the electronic book in both side by side traditional computer output formats as well as in a traditional codex page by page format.

2. The electronic book as recited in claim 1, and further including an input device, said input device being configured to receive data from removably insertable media formats.

3. The electronic book as recited in claim 2, wherein said controller is configured to receive data in a plurality of data file types and subsequently provide the user the data in said at least two modes.

4. The electronic book as recited in claim 3, wherein in said one of at least two modes, the electronic book provides data stored in the electronic book in a text format utilizing one of said at least two display screens and in selected outputs in both of said at least two display screens.

5. The electronic book as recited in claim 4, wherein in one of at least two modes, the electronic book provides data to a user in audio format.

6. The electronic book as recited in claim 5, wherein said controller is configured to receive and subsequently translate data entered from said input device in a first language and provide to the user the data in a second language in one of said at least two modes.

7. A portable data display device comprising:
a housing; said housing having a first portion and a second portion, said first portion and said second portion being hingedly attached;
controller; said controller being disposed within said housing, said controller for receiving, storing, processing and providing data to a user, said controller further being configured to provide the data to a user in at least a first mode and a second mode;
an input device; said input device operably connected to said controller, said input device configured to receive data utilizing a plurality of removably insertable media formats;
at least one user interface, said user interface operably connected to said controller, said user interface configured to control retrieval, manipulation and viewing of the data stored in the portable data display device; and
at least two display screens; with a first of said at least two display screens being integrally mounted into said first portion and said second of said at least two display screens being integrally mounted into said second portion of said housing, each of said display screens being operably connected to said controller, said each of said display screens configured to display data to the user in said first mode.

8. The portable data display device as recited in claim 7, and further including at least one audio speaker, said audio speaker operably connected to said controller provides data to a user in said second mode via said audio speaker.

9. The portable data display device as recited in claim 8, wherein said controller is configured to receive and process data from more than one data file type and subsequently provide the user the data in said first mode simultaneously utilizing said two display screens.

10 The portable data display device as recited in claim 9, wherein said controller is configured to receive and subsequently process data entered from said input device in a first language and provide to the user the data in a second language in either said first mode or said second mode.

11. The portable data display device as recited in claim 10, wherein said input device is a CD/DVD drive.

12. The portable data display device as recited in claim 11, wherein said two screens are further configured to provide data in said first mode to the user in low light conditions.

13. The portable data display device as recited in claim 12, and further including an output device; said output device operable connected to said controller, said output device functioning to provide data stored in the portable display device to a printer.

14. A portable electronic book that resembles a traditional bound paper book comprising:
a housing; said housing having a first portion and a second portion, said first portion and said second portion being hingedly attached, said housing being generally hollow and rectangular in shape;
control electronics; said control electronics being disposed within said housing, said control electronics for receiving, storing, manipulating and providing data to a user, said control electronics further being configured to provide the data to a user in a first and a second mode, wherein said first mode the data is provide to the user in a graphical format and wherein in said second mode the data is provided to the user in an audio format;
an input device; said input device being mounted within said second portion of said housing, said input device operably connected to said control electronics, said input device configured to receive data from a removably insertable media format;
two display screens; said display screens being integrally mounted into said first portion and said second portion of said housing, said display screens being operably connected to said control electronics, said display screens configured to display data to the user in said first mode; and
four user interfaces, said four user interfaces being mounted proximate said two display screens, said user interface operably connected to said control electronics, said user interface configured to control retrieval, manipulation and viewing of the data stored in the portable data display device.

15. The portable electronic book as recited in claim 14, wherein said control electronics are configured to receive and subsequently translate data entered from said input device in a first language and provide to the user the data in a second language in either said first mode or said second mode.

16. The portable electronic book as recited in claim 15, wherein said control electronics are configured to receive data from more than one data file and subsequently provide the user the data in said first mode simultaneously utilizing said two display screens.

17. The portable electronic book as recited in claim 16, wherein said input device is a CD/DVD drive.

18. The portable electronic book as recited in claim 17, and further including an output device; said output device operable connected to said control electronics, said output device functioning to provide data stored in the portable electronic book to a printer.

19. The portable electronic book as recited in claim 18, wherein said two screens are further configured to provide data in said first mode to the user in low light conditions.

20. The portable electronic book as recited in claim 19, wherein said four user interface are heat sensor touch pads.
